(19) United States
(12) Patent Application Publication
(10) Pub. No.: US 2024/0040577 A1
(43) Pub. Date: Feb. 1, 2024

(54) SYSTEM AND METHOD FOR SIDELINK RESOURCE SELECTION WITH BEAMFORMING

(71) Applicant: QUALCOMM Incorporated, San Diego, CA (US)

(72) Inventors: Jung Ho Ryu, Fort Lee, NJ (US); Sony Akkarakaran, Poway, CA (US); Tao Luo, San Diego, CA (US); Junyi Li, Fairless Hills, PA (US)

(21) Appl. No.: 17/878,772

(22) Filed: Aug. 1, 2022

(51) Int. Cl. H04W 72/14; H04L 1/08; H04L 1/18

(52) U.S. Cl. CPC H04W 72/14; H04L 1/08; H04L 1/1812

(57) ABSTRACT

Disclosed is a method for wireless communication. A first node determines that a beam failure recovery procedure, an initial beam pair establishment procedure, or a beam refinement procedure is completed. Based on the determination, the first node performs a sensing procedure that comprises receiving sidelink control information (SCI) from a third node. Based on the sensing procedure, the first node selects a sidelink grant for a sidelink transmission to a second node and transmits the sidelink transmission to the second node based on the selected sidelink grant.

### INTRODUCTION

Aspects of the present disclosure generally relate to wireless communications, and more particularly to techniques and apparatuses for sidelink (SL) communications.

Wireless communication systems are widely deployed to provide various telecommunication services such as telephony, video, data, messaging, and broadcasting. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems.

A wireless communication network may include a number of nodes such as base stations (BSs), and user equipments (UEs). A BS can support communication for a number of UEs. A UE may communicate with a BS via downlink and uplink. The downlink (or forward link) refers to a communication link from the BS to the UE, and the uplink (or reverse link) refers to a communication link from the UE to the BS. A BS may also be referred to as a Node B, a gNB, an access point (AP), a radio head, a transmit receive point (TRP), a New Radio (NR) BS, a 5G Node B, and/or the like. Further, a UE may also be referred to as an access terminal, a terminal, a mobile station, a subscriber unit, a station, and/or the like.

The above multiple access technologies have been adopted in various telecommunication standards to provide a common protocol that enables different user equipments to communicate on a municipal, national, regional, and even global level. LTE/LTE-Advanced is a set of enhancements to the Universal Mobile Telecommunications System (UMTS) mobile standard promulgated by the Third Generation Partnership Project (3GPP). New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation.

However, as the demand for mobile broadband access and low latency communications continues to increase, there exists a need for further improvements in wireless communications. Preferably, these improvements should be applicable to LTE and/or NR, and/or also to other access technologies and the telecommunication standards that employ these technologies.

### SUMMARY

In some aspects of the present disclosure, a method for wireless communication is disclosed, the method being performed by a first node such as UE. The method may include determining that a beam failure recovery (BFR) procedure, an initial beam pair establishment procedure, or a beam refinement procedure is completed, performing, based on the determination, a sensing procedure, wherein the sensing procedure comprises receiving SL control information (SCI) from a third node, selecting, based on the sensing procedure, a sidelink (SL) grant for a SL transmission to a second node, and transmitting the SL transmission to the second node based on the selected SL grant.

In some aspects of the present disclosure, an apparatus for wireless communication of a first node, may include means for determining that a beam failure recovery (BFR) procedure, an initial beam pair establishment procedure, or a beam refinement procedure is completed, means for performing, based on the determination, a sensing procedure, wherein the sensing procedure comprises receiving SL control information (SCI) from a third node, means for selecting, based on the sensing procedure, a sidelink (SL) grant for a SL transmission to a second node, and means for transmitting the SL transmission to the second node based on the selected SL grant.

In some aspects of the present disclosure, an an apparatus for wireless communication of a first node may include a memory and one or more processors coupled to the memory, the memory and the one or more processors may be configured to determine that a beam failure recovery (BFR) procedure, an initial beam pair establishment procedure, or a beam refinement procedure is completed, perform, based on the determination, a sensing procedure, wherein the sensing procedure comprises receiving SL control information (SCI) from a third node, select, based on the sensing procedure, a sidelink (SL) grant for a SL transmission to a second node, and transmit the SL transmission to the second node based on the selected SL grant.

In some aspects of the present disclosure, a non-transitory computer-readable medium may store one or more instructions (e.g. a computer program) for wireless communication. The one or more instructions, when executed by one or more processors, for instance one or more processors of a first node such as a UE, may cause the one or more processors to determine that a beam failure recovery (BFR) procedure, an initial beam pair establishment procedure, or a beam refinement procedure is completed, perform, based on the determination, a sensing procedure, wherein the sensing procedure comprises receiving SL control information (SCI) from a third node, select, based on the sensing procedure, a sidelink (SL) grant for a SL transmission to a second node, and transmit the SL transmission to the second node based on the selected SL grant.

The foregoing has outlined rather broadly features of examples according to the present disclosure. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited aspects of the present disclosure can be understood in detail in the following a more particular description, is provided by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communication network including SL communications, in accordance with various aspects of the present disclosure.

FIG. 2 is a block diagram conceptually illustrating an example of a node, such as a BS, and a UE in communication with other nodes such as other UEs in a wireless communication network, in accordance with various aspects of the present disclosure.

FIG. 3 is a block diagram conceptually illustrating an example of a radio frame structure in a wireless communication network, in accordance with various aspects of the present disclosure.

FIG. 4 is a diagram illustrating full SL channel sensing and SL transmission resource selection in accordance with various aspects of the present disclosure.

FIG. 5 is a diagram illustrating resource reservation for SL transmissions of multiple transport blocks (TBs) in accordance with various aspects of the present disclosure.

FIG. 6 is a diagram illustrating periodic-based partial sensing (PBPS) in accordance with various aspects of the present disclosure.

FIG. 7 is a diagram illustrating contiguous partial sensing (CPS) in accordance with various aspects of the present disclosure

FIG. 8A illustrates an exemplary process flow for creating an aperiodic mode 2 SL transmission grant according to aspects of the present disclosure.

FIG. 8B illustrates an exemplary process flow for creating a periodic mode 2 SL transmission grant according to aspects of the present disclosure.

FIGS. 9A and 9B are block diagrams conceptually illustrating examples of SL transmissions using beamforming, in accordance with various aspects of the present disclosure.

FIG. 9C is a block diagram conceptually illustrating examples of Sl transmissions using beamforming, in accordance with various aspects of the present disclosure

FIG. 10 is a diagram illustrating an example process performed, for example, by a node such as a Tx UE, in accordance with various aspects of the present disclosure.

### DETAILED DESCRIPTION

Various aspects of the present disclosure are described in more detail hereinafter with reference to the accompanying drawings.

This disclosure may, however, be implemented in many different forms and should not be construed as limited to any specific structure or function presented throughout this disclosure. Rather, these aspects are provided so that this disclosure will be thorough and complete, and will fully convey the scope of the present disclosure to those skilled in the art. Based on the teachings herein one skilled in the art should appreciate that the scope of the present disclosure is intended to cover any aspect of the present disclosure disclosed herein, whether implemented independently of or combined with any other aspect of the present disclosure. For example, an apparatus may be implemented or a method may be practiced using any number of the aspects set forth herein. In addition, the scope of the present disclosure is intended to cover such an apparatus or method which is practiced using other structure, functionality, or structure and functionality in addition to or other than the various aspects of the present disclosure set forth herein. It should be understood that any aspect of the present disclosure disclosed herein may be implemented by one or more elements of a claim. While specific feature combinations are described in the following with respect to certain aspects of the present disclosure, it is to be understood that not all features of the discussed examples must be present for realizing the technical advantages of the devices, systems, methods and computer programs disclosed herein. Disclosed aspects may be modified by combining certain features of one aspect with one or more features of other aspects. A skilled person will understand that features, steps, components and/or functional elements of one aspect can be combined with compatible features, steps, components and/or functional elements of any other aspect of the present disclosure.

Several aspects of communication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with 3G and/or 4G wireless technologies, aspects of the present disclosure can be applied in other generation-based communication systems, such as 5G and later, including NR technologies and Open RAN (O-RAN) technologies.

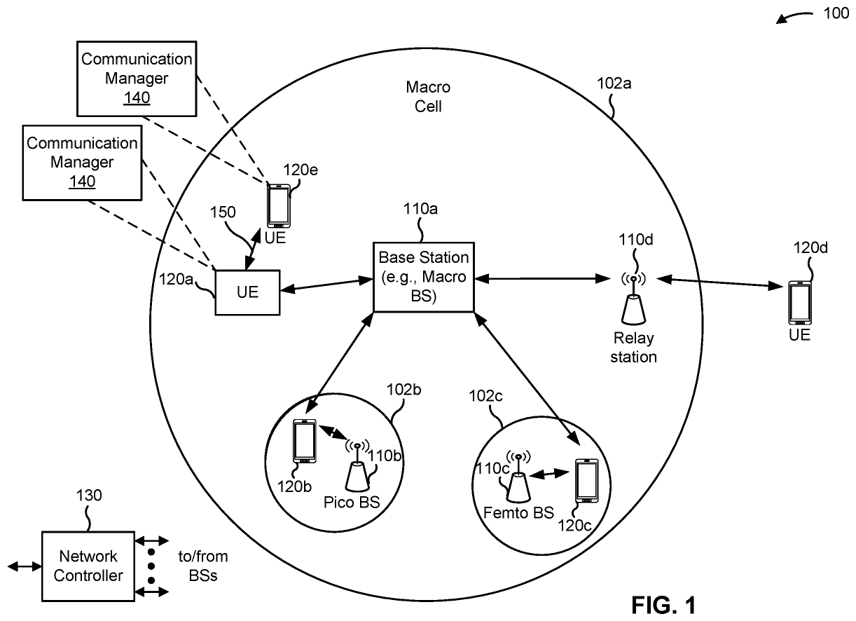

FIG. 1 is a diagram illustrating a wireless network 100 in which aspects of the present disclosure may be practiced. The wireless network 100 may be an LTE network, an O-RAN network a 5G or NR network, and/or the like. Wireless network 100 may include a number of nodes such as BSs 110 (shown as BS 110a, BS 110b, BS 110c, and BS nod), and UEs 120 (shown as UE 120a, UE 120b, UE 120C, UE 120d, and UE 120e) and other network entities. A BS is an entity that communicates with UEs and may also be referred to as a base station, a NR BS, a Node B, a gNB, a 5G node B (gNB), an access point (AP), a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 10a may be a macro BS for a macro cell 102a, a BS 10b may be a pico BS for a pico cell 102b, and a BS 10c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station BS 110d may communicate with macro BS 110a and a UE 120d in order to facilitate communication between BS 110a and UE 120d. A relay station may also be referred to as a relay BS, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 Watts) whereas pico BSs, femto BSs, and relay BSs may have lower transmit power levels (e.g., 0.1 to 2 Watts).

A network controller 130 may couple to one or more (e.g., a set of) BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c, 120d, 120e, and/or the like) may be dispersed throughout wireless network 100, and each UE may be stationary or mobile. A UE may communicate with one or more BSs in wireless network 100, may communicate with another UE (e.g., UE 120a and UE 120e, as illustrated in FIG. 1) via SL transmissions (e.g., link 150 shown in FIG. 1 as connecting UE 120a and UE 120e), and/or the like.

In some cases, two or more nodes (e.g., UEs) may communicate with each other using SL transmissions. Applications of such SL communications may include public safety, proximity services, UE-to-network relaying, vehicle-to-everything (V2X) communications, Internet of Everything (IoE) communications, Internet-of-Things (IoT) communications, mission-critical mesh, and/or various other suitable applications. Generally, a SL transmission may refer to a transmission sent from one node (e.g., UE1) to another node (e.g., UE2) without relaying that transmission through a scheduling entity (e.g., UE or BS), even though such a scheduling entity may be involved for scheduling and/or control purposes. In some examples, the SL transmissions may be communicated using a licensed spectrum (unlike wireless local area networks, which may use an unlicensed spectrum).

A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered as machine-type communication (MTC) or evolved or enhanced machine-type communication (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node (e.g., UE, BS, or the like) may provide, for example, connectivity for or to a network (e.g., a wide area network such as Internet or a cellular network) via a wired or wireless communication link. Some UEs may be considered as Internet-of-Things (IoT) devices, and/or may be implemented as NB-IoT (narrowband internet of things) devices. Some UEs may be considered as a Customer Premises Equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, when the first network node is configured to transmit information to the second network node, the first network node may be configured to provide, send, output, communicate, or transmit information to the second network node. Similarly, in this example and consistent with this disclosure, when the first network node is configured to transmit information to the second network node, the second network node may be configured to receive, obtain, or decode the information that is provided, sent, output, communicated, or transmitted by the first network node.

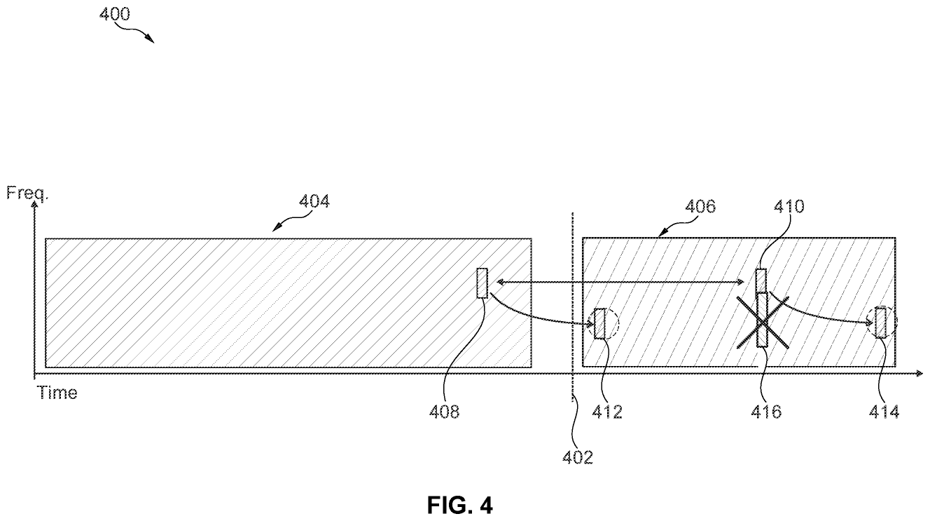

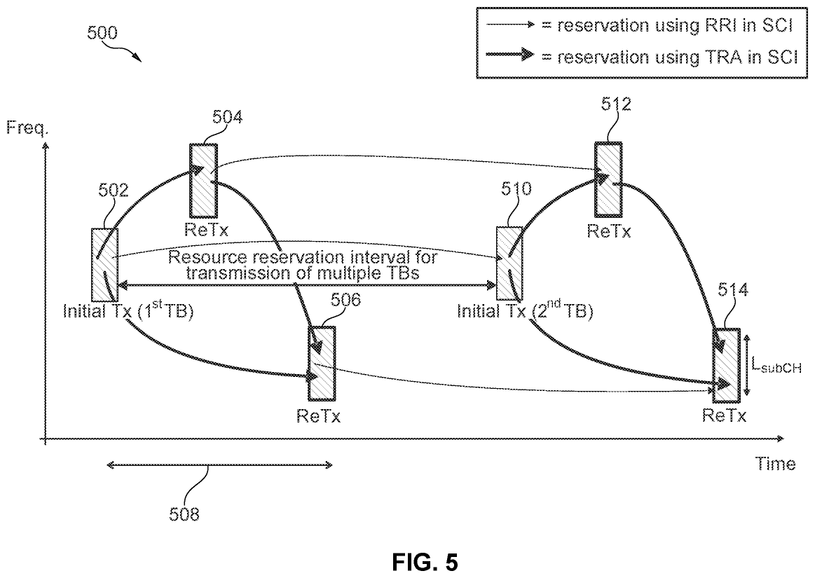

As shown in FIG. 1, the UE 120 may include a communication manager 140, e.g. implemented in hardware or software. As described in more detail elsewhere herein, the communication manager 140 may determine that a BFR procedure, an initial beam pair establishment procedure, or a beam refinement procedure is completed. Expressed differently, the communication manager 140 may determine that at least one or more of a BFR procedure, an initial beam pair establishment procedure, or a beam refinement procedure is completed. Based on this determination, the communication manager 140 may perform a sensing procedure (for examples see FIGS. 4 and 5), wherein the sensing procedure may comprise receiving SCI from another UE on a SL (e.g., link 150) between the UE 120 (e.g., UE 120a) and another UE 120 (e.g., UE 120e). Based on the sensing procedure, the communication manager 140 may select a SL grant for a SL transmission to a further UE 120 (e.g., UE 120f). For example, such a SL grant may comprise transmission resources for a SL transmission, and transmission resources for one or more HARQ retransmissions and, optionally a transmission periodicity. The communication manager 140 may then transmit the SL transmission to the other UE 120 based on the selected SL grant. Additionally, or alternatively, the communication manager 140 may perform one or more other operations described herein. For example, in some aspects, the sensing procedure may be performed by the communication manager based on a receive beam configuration of the UE 120 (e.g., UE 120a), wherein the receive beam configuration is determined based on the completed BFR procedure, the completed initial beam pair establishment procedure, or the completed beam refinement procedure.

As indicated above, FIG. 1 is provided merely as an example. Other examples may differ from what is described with regard to FIG. 1.

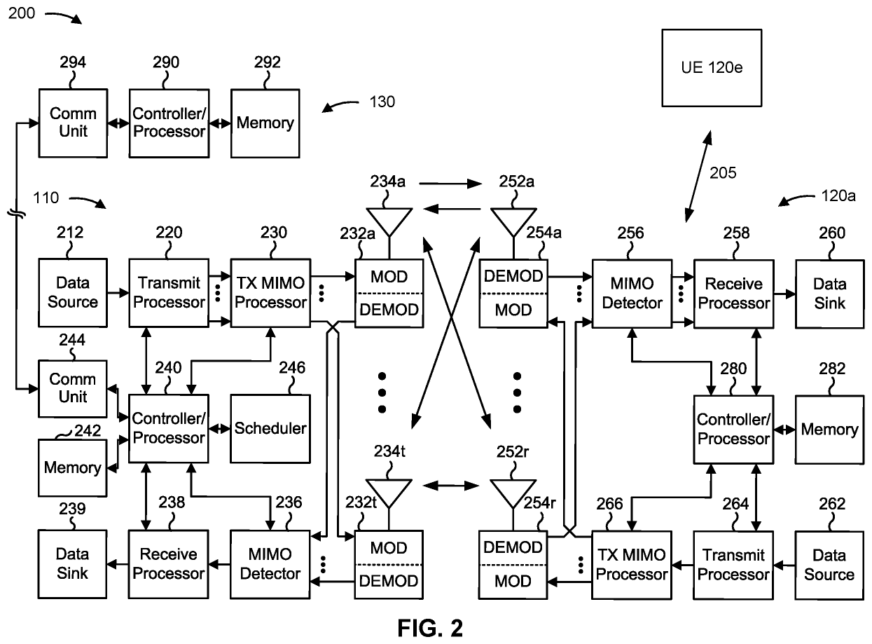

FIG. 2 shows a block diagram of a design 200 of a node such as a BS 110, and a UE 120, such as UE 120a and UE 120e, which may be one of the BS and one of the UEs in FIG. 1. UE 120e may be equipped analogously to UE 120a. BS 110 may be equipped with T antennas 234a through 234t, and UE 120a and UE 120e may be equipped with R antennas 252a through 252r, where in general T≥1 and R≥1.

At BS 110, a transmit processor 220 may receive data from a data source 212 for one or more UEs, select one or more modulation and coding schemes (MCS) for each UE based on channel quality indicators (CQIs) received from the UE, process (e.g., encode and modulate) the data for each UE based on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (Tx) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 (e.g., 232a through 232t) may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120a, antennas 252a through 252r may receive the downlink signals from base station 110 and/or other base stations, may receive sidelink signals from another UE 120e (e.g., UE 120a may receive SL signals from UE 120e and/or vice-versa) and may provide received signals to demodulators (DEMODs) 254a through 254r, respectively. Each demodulator 254 (e.g., 254a through 254r) may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120a to a data sink 260, and provide decoded control information and system information to a controller/processor 280. A channel processor may identify reference signal received power (RSRP), received signal strength indicator (RSSI), reference signal received quality (RSRQ), channel quality indicator (CQI), and/or the like. In some aspects, one or more components of UE 120a and/or UE 120e may be included in a housing.

On the uplink or on a SL 205, at UE 120a, or at UE 120e, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals. The symbols from transmit processor 264 may be precoded by a Tx MIMO processor 266 if applicable, further processed by modulators 254a through 254r (e.g., for DFT-s-OFDM, CP-OFDM, and/or the like), and transmitted to base station 110 on the uplink and/or to another UE 120e on the sidelink. At base station 110, the uplink signals from UE 120a, UE 120e, and other UEs may be received by antennas 234 (e.g., 234a through 234t), processed by demodulators 232, detected by a MIMO detector 236 if applicable, and further processed by a receive processor 238 to obtain decoded data and control information sent by UE 120a and/or UE 120e. Receive processor 238 may provide the decoded data to a data sink 239 and the decoded control information to controller/processor 240. Base station 110 may include communication unit 244 and communicate to network controller 130 via communication unit 244. Network controller 130 may include communication unit 294, controller/processor 290, and memory 292.

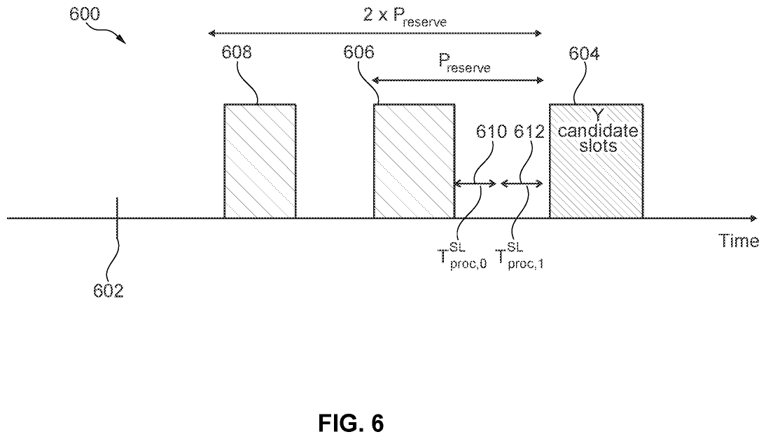

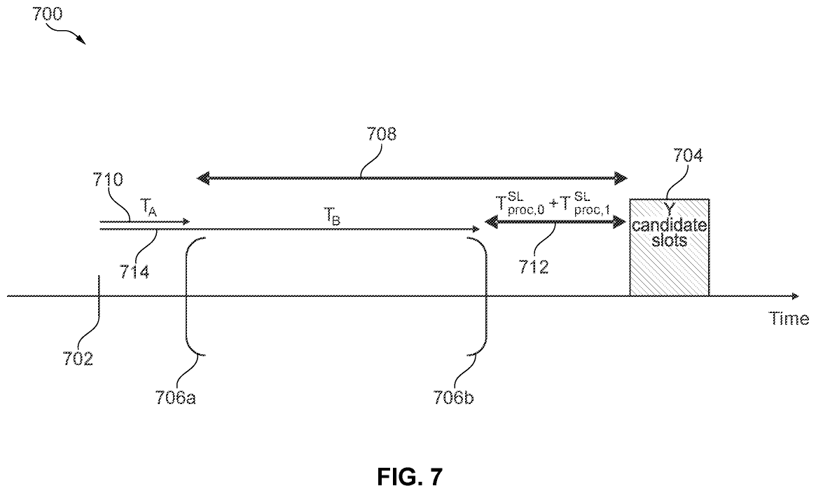

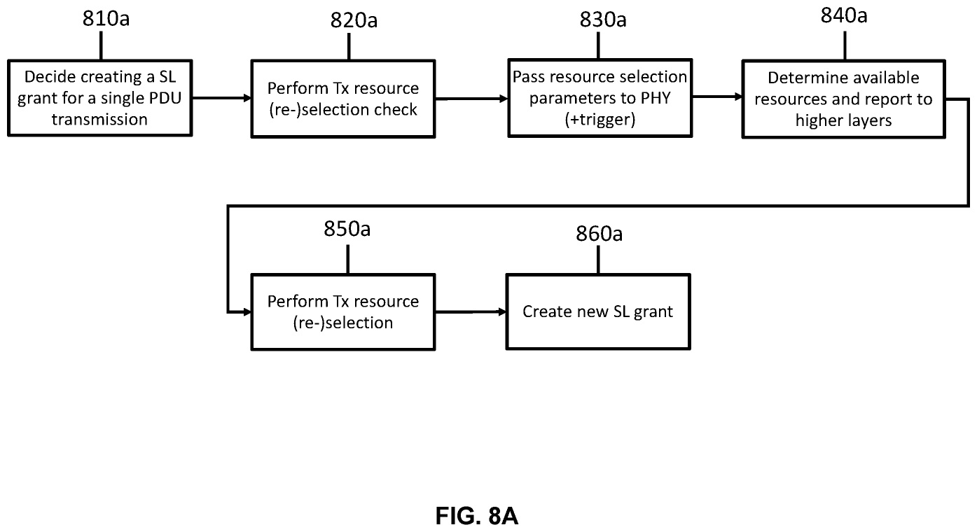

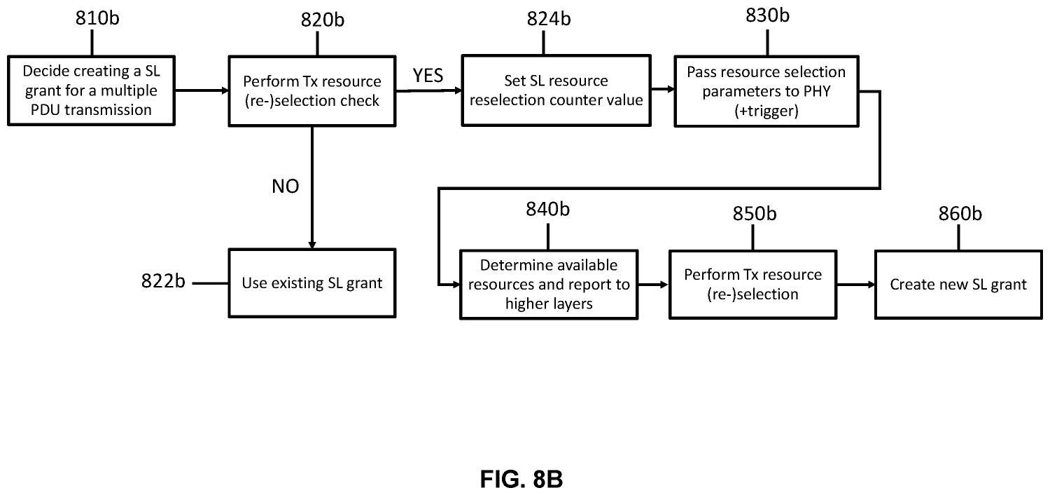

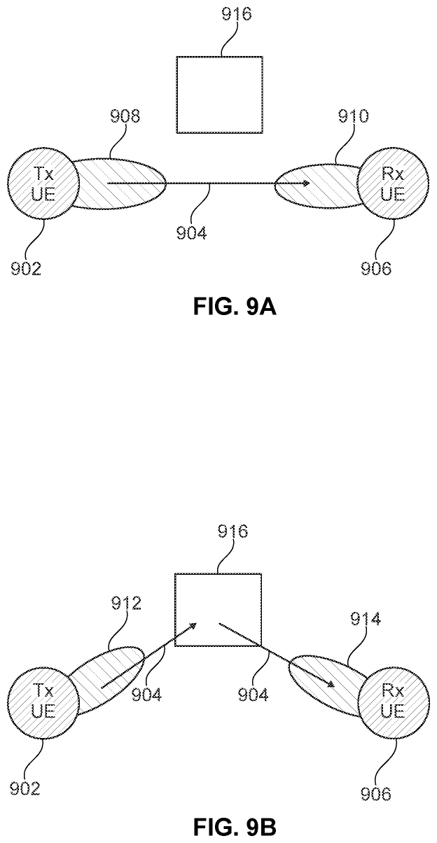

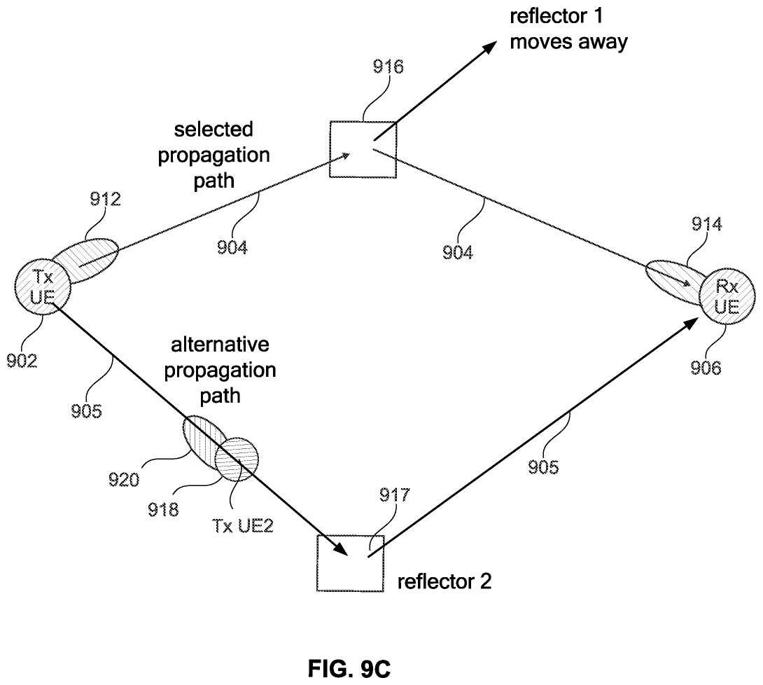

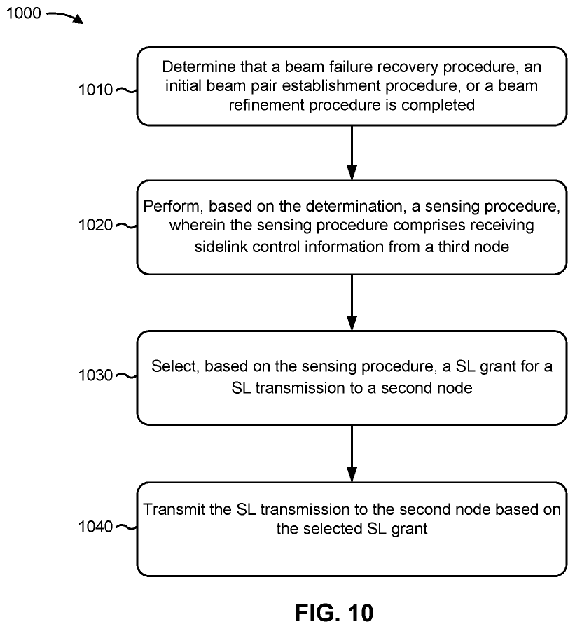

Controller/processor 240 of base station 110, controller/processor 280 of UE 120a, and/or any other component(s) of FIG. 2 may perform one or more techniques associated with SL resource selection with beamforming, as described in more detail elsewhere herein. For example, controller/processor 280 of UE 120a, and/or any other component(s) of FIG. 2 may perform or direct operations of, for example, methods disclosed herein, e.g., with reference to FIG. 5, FIG. 6, FIG. 7, FIG. 8, FIG. 9, or FIG. 10, and/or other methods and processes as described herein. Memories 242 and 282 may store data and program codes for base station 110 and UE 120a, respectively, such as a computer program for SL sensing and resource selection described elsewhere herein. A scheduler 246 may schedule UEs for data transmission on the downlink, uplink, or SL. In some aspects disclosed herein, e.g. in NR mode 2 SL, the controller/processor 280 may determine a SL grant e.g., for a SL transmission to UE 120e, based on a SL channel sensing and resource selection procedure with beamforming as disclosed herein.

In some aspects, a UE 120 (e.g., UE 120a and/or UE 120e) may thus include means for determining that a BFR procedure, an initial beam pair establishment procedure, or a beam refinement procedure is completed. UE 120 (e.g., UE 120a and/or UE 120e) may further include means for performing, based on the determination, a sensing procedure, wherein the sensing procedure comprises receiving SCI from another UE. UE 120 (e.g., UE 120a and/or UE 120e) may further include means for selecting, based on the sensing procedure, a SL grant for a SL transmission to another UE and means for transmitting the SL transmission to the other UE based on the selected SL grant. UE 120 (e.g., UE 120a and/or UE 120e) may also include means for carrying out one or more other operations described herein.

Similarly, in some aspects, a UE 120 (e.g., UE 120a and/or UE 120e) may thus include a memory and one or more processors coupled to the memory, the memory and the one or more processors may be configured to determine that a BFR procedure, an initial beam pair establishment procedure, or a beam refinement procedure is completed, to perform, based on the determination, a sensing procedure, wherein the sensing procedure comprises receiving SCI from another UE, to select, based on the sensing procedure, a SL grant for a SL transmission to another UE, and to transmit the SL transmission based on the selected SL grant. The one or more processors, and the memory of UE 120 (e.g., UE 120a and/or UE 120e) may be further configured to perform one or more other operations described herein.

As indicated above, FIG. 2 is provided merely as an example. Other examples may differ from what is described with regard to FIG. 2.

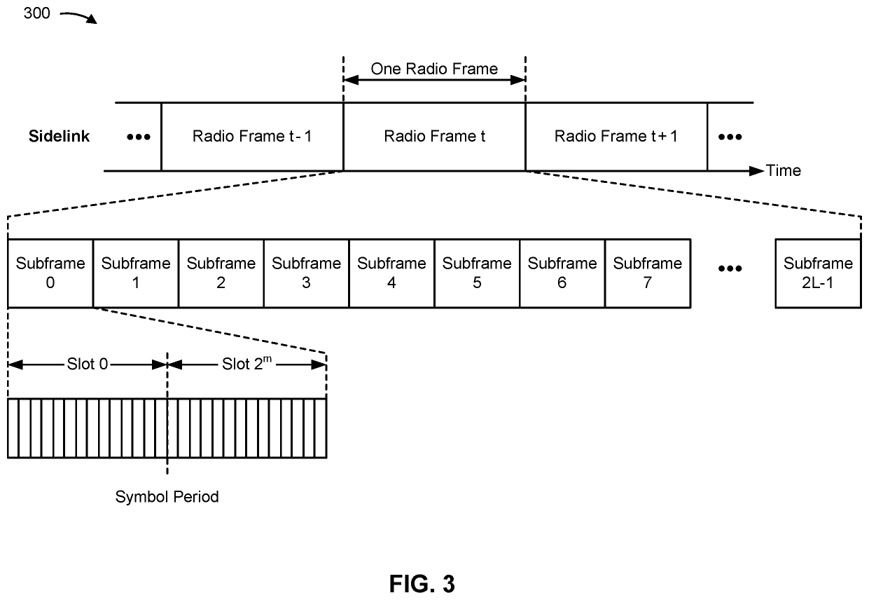

FIG. 3 shows an example radio frame structure 300 for communicating, on a SL between UEs, in a wireless communications system (e.g., LTE, 5G NR, O-RAN and/or the like). The transmission timeline for the SL may be partitioned into units of radio frames, where t represents time. Each radio frame may have a predetermined duration (e.g., 10 milliseconds (ms)) and may be partitioned into a plurality of subframes with indices of 0 through 2L−1. Each subframe may include two slots. As an example, each radio frame may be partitioned into 10 subframes 0 through 9 and 20 slots with indices of 0 through 19. Each slot may include a plurality of symbol periods, such as seven symbol periods for a normal cyclic prefix or six symbol periods for an extended cyclic prefix.

In some aspects, a UE (e.g., UE 120a, UE 120e, and/or the like) may transmit, to another UE (e.g., UE 120a, UE 120e, and/or the like) on a SL, one or more SL communications in a transmission period, which may include one or more slots included in frame structure 300. In some aspects, the other UE may receive the one or more SL communications, may generate feedback for the one or more sidelink communications, may incorporate the feedback into one or more feedback communications, and may transmit, to the UE on the sidelink, the one or more feedback communications in one or more symbols and/or slots included in a reporting period, in frame structure 300, configured for the sidelink.

While some techniques are described herein in connection with frames, subframes, slots, and/or the like, these techniques may equally apply to other types of wireless communication structures, which may be referred to using terms other than “frame,” “subframe,” “slot,” and/or the like in 5G NR. In some aspects, a wireless communication structure may refer to a periodic time-bounded communication unit defined by a wireless communication standard and/or protocol.

As indicated above, FIG. 3 is provided merely as an example. Other examples may differ from what is described with regard to FIG. 3.

In some aspects of the present disclosure, multiple deployment scenarios for SL communications in terms of a relationship between the SL communication and an overlaid cellular network may exist. In one aspect, nodes (e.g., wireless devices, UEs, etc.) involved in SL communications may be under coverage of an overlaid cellular network (e.g., a NR network). The overlaid cellular network may control SL communications. For instance, the overlaid network may schedule the SL transmissions. In some aspects, such a network scheduled SL operation (sometimes also referred to as in-coverage operation) operation may sometimes use (or be referred to as) a resource-allocation mode 1 (e.g., a NR mode 1 SL). In case of the in-coverage operation, SL communications may share a carrier frequency with the overlaid cellular network. Alternatively, network scheduled SL communications may take place on a sidelink-specific carrier frequency different from a carrier frequency (or carrier frequencies) of the overlaid cellular network. In another aspect, the nodes involved in SL communications may not be network scheduled, e.g. may not be within the coverage of an overlaid cellular network (sometimes also referred to as out-of-coverage operation). In some aspects, out-of-coverage operation may sometimes use (or be referred to as) a resource-allocation mode 2 (e.g., a NR mode 2 SL). In out-of-coverage operation, decisions on SL transmissions may be determined by a node involved in SL communications (e.g., a transmitting device, a Tx UE, etc.) For instance, as discussed elsewhere herein, in out-of-coverage operation, a node may select a SL transmission grant based on a sensing and resource selection procedure. Such decision may include selecting a set of transmission resources, e.g., a set of OFDM resource elements for use in the SL transmission.

In some aspects of the present disclosure, SL transmissions (e.g., NR mode 2 SL transmissions) may be based on a multiplexing technique such as OFDM. A node which is configured for SL transmissions may be configured (e.g., pre-configured, statically or dynamically configured by the network) with a SL resource (also referred to as transmission resources) pool. A sidelink resource pool may define, among others, overall time/frequency resources that may be used for SL communications. In a time domain, a resource pool may comprise a set of slots repeated over a resource pool period (e.g., a resource pool period associated with a resources pool such as in NR). Thus, in the time domain, a resource pool may be defined by specifying, among others, a configurable resource-pool period, a configurable set of SL slots within the resource-pool period, and/or the like. Expressed differently, in some aspects, a resource-pool may have a slot-based granularity in the time domain. In a frequency domain, the resource pool may comprise a set of consecutive subchannels, where a subchannel may be composed of a number of resource blocks (e.g., a number of consecutive resource blocks, for instance, 10, 15, 20, 25, 50, 75 or 100 consecutive resource blocks) and/or a configurable resource-pool bandwidth corresponding to a set of consecutive subchannels. In some aspects, the resource pool may be defined by additionally specifying a frequency-domain location of a subchannel of the resource pool.

In some aspects of the present disclosure, a transmitting node (e.g., a Tx UE) may facilitate a sensing and resource-selection procedure (e.g. of another node, such as a Tx UE) by providing one or more resources-reservation announcements. A resource reservation announcement may provide information (for instance, to other nodes) about which set of resources a node (e.g., nearby Tx UE) has selected for future SL transmissions. For instance, in some aspects of the present disclosure, a node may reserve resources, for instance, for up to two additional transmissions within a time window corresponding to a number of slots including a current slot (e.g., 32 slots including the current slot). Each of these future transmissions may have the same bandwidth as the transmission in the current slot but may have different frequency-domain locations. Information about such reserved resources may be provided in terms of time offsets (for instance, Δt₁ and Δt₂) and/or frequency shifts (for instance, Δf₁ and Δf₂) and may be provided as part a resource reservation within control information (e.g., SCI, such as 1st stage SCI in NR). In addition, or alternatively, a node may reserve periodically occurring sets of resources for a SL transmissions. Each of such periodically occurring set of resources may have the same structure (bandwidth, frequency shifts, and/or relative time offsets) as an initial transmission and may periodically occur with a period Tp. In some aspects, the period Tp may range from 1 ms up to 900 ms. In some aspects, a set of allowed periods Tp may be configured by higher layers (e.g., via RRC signaling such as sl-ResourceReservePeriodList message in NR). In some aspects of the present disclosure, control information (e.g., SCI) may comprise one or more of a time resource assignment (TRA) field, a frequency resource assignment (FRA) field, or a resource reservation interval (RRI) field.

In accordance with one or more aspects of the present disclosure, a node (e.g., a UE 120a, 120e, a Tx UE) may perform a sensing and resource selection procedure by which the node may select a set of resources to use for one or more SL transmission. Such a sensing and resource selection procedure may be based on resource reservations (e.g., in control information, for instance, based on TRA/FRA/RRI fields in SCI) announced by other devices. A SL transmission may be assigned a delay budget implying that this SL transmission is expected to be transmitted within a certain time window. Alternatively, or in addition, the SL transmission may be assigned a priority.

According to an aspect of the present disclosure, a device (e.g., a UE 120a, 120e, a Tx UE or the like) may perform channel sensing such as partial sensing or full sensing. FIG. 4 is a diagram illustrating channel sensing and resource selection 400 in accordance with various aspects of the present disclosure. A node (e.g. a Tx UE) may generate (or obtain) a resource selection trigger in a slot 402 (e.g., SL slot n) such that the node may decide to perform a sidelink transmission and may need to determine resources available for such transmission.

In some aspects, the node may perform a Tx resource (re-)selection check that may generate a resource selection trigger. For example, the node may perform a Tx resource (re-)selection check for checking if a Tx resource (re-)selection process, e.g., based on a sensing procedure as disclosed herein, should be performed. For instance, the node, e.g. via a MAC element of the node, may repeatedly perform a Tx resource (re-)selection check until the corresponding pool of SL resources is released by RRC signaling, or if the node decides to cancel creating a selected sidelink grant corresponding to transmissions of multiple MAC PDUs.

The determining of resources available for such a SL transmission may be based on SL channel sensing. More specifically, the node may be sensing (e.g., monitoring) the SL channel (e.g., in the entire sensing window 404), for example. The node may intend to identify available resources for the SL transmission in a resource selection window 406. The node may be sensing/monitoring for SCIs transmitted by nearby nodes, wherein the SCIs may comprise information (e.g., one or more resources-reservation announcements) about resources that nearby nodes will be using for future sidelink transmissions.

For instance, as shown in FIG. 4, UE1 (e.g., UE 120a, 120e, a Tx UE, a node or the like) may receive, in slot m, SCI1 408 from UE2. UE1 may determine that SCI1 408 indicates a resource reservation interval (RRIᵢ) and a transmission priority pᵢ. Further, UE1 may determine that a reference signal received power (RSRP) is higher than a threshold based on a pair of priorities pᵢ, pⱼ, for instance, a threshold Th(pᵢ, pⱼ) that is a function of the pair of priorities pᵢ, pⱼ. The priority pⱼ may be associated with a SL transmission UE1 intends to transmit. Expressed differently, determination of resources available for the SL transmission may be based on a RSRP of the received SCIs, a priority pⱼ of the SL transmission by UE1 (e.g., Tx UE's transmission), and a priority pᵢ indicated by the received SCIs. Continuing with FIG. 4, SC1 may comprise RRIᵢ≠0 indicating a future (e.g., periodic) SL transmission using a resource 410. In addition, or alternatively, SCI1 may comprise TRA/FRA fields indicating a future SL transmission in a resource 412. In a similar manner, a SL transmission in the resource 410 may indicate (e.g., via TRA/FRA fields) a future sidelink transmission in a resource 414, e.g. a potential HARQ retransmission for the SL transmission in resource 410.

Upon obtaining the trigger in the slot 402, the node may, based on received reservations transmitted by nearby nodes, determine which resources are available for its own SL transmissions. A candidate resource (e.g., candidate single-slot resource, such as R_{x,y} in NR) may be defined as a set of a number (e.g., L_{subCH} in NR) contiguous sub-channels (e.g., with a sub-channel x+j in a slot ty in a sidelink resource pool, where j=0, . . . , L_{subCH}−1). In some aspects, the number L_{subCH} may refer to a number of sub-channels to be used for a sidelink transmission in a slot and may be configured by higher layers (e.g., via RRC signaling). The device may, from a set of candidate resources (e.g., candidate single-slot resources) within the resource selection window 406, determine to selectively exclude resource 416 (e.g., contiguous L_{subCH} resources, such as resource R_{x,y} in NR) in view of an overlap with the reserved resource 410. In a similar manner, the device may determine to exclude any candidate resource (not shown) from the set of candidate resources in view of an overlap with any resource reserved by any nearby UEs (determined by the device by sensing/monitoring for transmissions/reservations by nearby UEs).

A physical (PHY) layer of the device may then provide a set of available resources that the device may use to select one or more resources for the SL transmission (i.e., the set of remaining candidate resources, which may be sometimes referred to as S_{A}) to a medium access control (MAC) layer. Thereupon, the MAC layer may select one or more resources to be used by the SL transmission and effectuate the SL transmission in the selected one or more resources by the PHY layer (not shown in FIG. 4).

In accordance with an aspect of the present disclosure, a node may intend to transmit multiple transport blocks (TBs) to another node via SL communications. FIG. 5 is a diagram 500 illustrating resource reservation for SL transmissions of multiple TBs in accordance with various aspects of the present disclosure. In an aspect, a node may transmit an initial transmission of a first TB in a time/frequency resource 502. Using a TRA/FRA field in SCI associated with this initial transmission of the first transport block, the node may reserve a number of resources (e.g., up to 2 resources, such as R_{x,y} in NR) for future transmissions. In FIG. 5, the SCI of the initial transmission (e.g., initial Tx) of the first TB in the resource 502 reserves a resource 504 and a resource 506, for instance, for retransmissions (e.g., ReTx) of the initial transmission. The resource 504 may involve a minimum time gap relative to the resource 502. Similarly, the resource 506 may involve a minimum time gap relative to the resource 504. In addition, the resources for a transmission (e.g., 502) and corresponding retransmissions (e.g., 504 and 506) may be up to a number of slots (e.g., 31 slots) apart. In one or more aspects of the present disclosure, the resources 502, 504 and 506 may be collectively referred to as one period 508. One period may comprise the initial transmission and subsequent retransmissions of the initial transmission.

In addition, an RRI field in SCI, or a RRI field in combination with a TRA/FRA field of a SL transmission may reserve a set of periodic resources for SL transmissions of multiple TBs. For instance, the SCI of the initial transmission of the first TB in the resource 502 may reserve, by using an RRI field, a periodic resource, such as a resource 510 (shown in FIG. 5) or subsequent periodic resources (not shown). The periodic resources (e.g., the resource 510) may be used for transmitting subsequent TBs of the multiple TBs following the first TB. For instance, an initial transmission (e.g., initial Tx) of a second TB may be transmitted in the resource 510. Similarly, the retransmission of the first TB in the resource 504 may reserve, by using RRI in its SCI, a periodic resource, such as a resource 512 (shown in FIG. 5) or subsequent periodic resource (not shown). The periodic resource (e.g., the resource 512) may be used for transmitting retransmissions of the subsequent TBs. Similarly, RRI in SCI of the retransmission in the resource 506 may reserve a periodic resource comprising a resource 514 (shown in FIG. 5) or subsequent resources (not shown). Further, the RRI field of the SCI of the first transmission in combination with the TRA/FRA field of the RCI may reserve resources 512 and 514 in the subsequent SL period. In one or more aspects, the periodicity indicated in RRI may be selected from a set of allowed periods. For example, the set of allowed periods may be configured by higher layers (e.g., via RRC signaling such as sl-ResourceReservePeriodList message in NR). In other aspects, alternatively or in addition to the above, RRI of the sidelink transmission in the resource 510 may reserve the resources 512 and 514 by using respective TRA/FRA.

In one or more aspects of the present disclosure, partial sensing may be used to reduce power consumption of a nodenode (e.g., a UE 120a, 120e, a Tx UE or the like) in contrast to the aforementioned full sensing. To avoid sensing the channel all the time (e.g., during the entire sensing window 404 shown in FIG. 4), the node may only sense (e.g., monitor) a fraction of time/frequency resources (e.g., of a channel). To reduce the sensing effort, the node may determine a set of candidate slots (e.g., the set Y of candidate slots) in which the node may intend to perform sidelink transmissions. Partial sensing may consider reservation (e.g., announcement) rules for sidelink transmissions (e.g., reservation rules using TRA/FRA and/or RRI in SCIs, as described in FIG. 5) and the set of candidate slots. In various aspects of the present disclosure, partial sensing may include periodic-based partial sensing (PBPS) or contiguous partial sensing (CPS). For instance, in accordance with one or more aspects of the present disclosure, PBPS may be used to determine one or more resources that are reserved by nearby nodes (e.g., Tx UEs) performing periodic transmissions (e.g., sidelink transmissions) by their own. Such determining may be based on RRIs in SCI of the sensed (e.g., monitored, and/or received) sidelink transmissions (including initial transmissions and retransmissions). Further, for instance, in accordance with one or more aspects of the present disclosure, CPS may be used to determine one or more resources that are reserved by nearby nodes (e.g., Tx UEs) for retransmission. Such determining may be based on one or more TRAs/FRAs in SCI of the sensed (e.g., monitored, and/or received) sidelink transmissions (and/or retransmissions).

As described above, according to an aspect of the present disclosure, a node (e.g., a UE 120a, 120e, a Tx UE or the like) may perform periodic-based partial sensing (PBPS). FIG. 6 is a diagram illustrating PBPS 600 in accordance with various aspects of the present disclosure. The node may, for example, similar as in case of full sensing, generate (or obtain) a resource selection trigger 602 in a slot (e.g., SL slot n). Based on a delay budget, a priority, and/or the like, of a sidelink transmission to be transmitted, and/or based on other considerations, the node may determine a set of candidate slots 604 (e.g., Y candidate slots in NR) in which it intends to transmit the sidelink transmission. However, in PBPS, unlike in full sensing, the node does not perform sensing (e.g., monitoring) of the channel substantially all the time prior to the resource selection trigger 602. Rather, in PBPS, to determine which resources in the set 604 are reserved by nearby nodes (e.g., UEs), the node may sense (e.g., monitor) the channel only on certain slots prior to the set 604 based on control information (e.g., comprising one or more of reservations, periodicities, TRA/FRA, RRI, and/or the like) indicated in sidelink transmission by other nodes, for instance, as described in the context of FIG. 5.

In one aspect of the present disclosure, in PBPS, the node may perform sensing only in sensing occasions having a periodic relationship with slots comprised in the set 604. For instance, the node may perform sensing in a set of slots 606. The set of slots 606 may be composed of slots having a certain time offset to slots in the set of candidate slots 604. Such offset may be equal to a periodicity of sidelink transmissions (by nearby nodes) which may be expected by the node, for example, based on various configurations. Such configurations may include a periodicity Pᵣₑₛₑᵣᵥₑ which may be indicated by nearby nodes in one or more RRIs in SCIs. In some aspects of the present disclosure, the periodicity may only assume values from a set of allowed periodicities configured by higher layers (e.g., via RRC signaling such as sl-ResourceReservePeriodList message in NR). Thus, to determine resources in the candidate set 604 which are reserved by nearby nodes, the node may need to only sense the channel in a number of slots (e.g., a set of slots having a relationship k×Pᵣₑₛₑᵣᵥₑ slots, with k being a positive integer) prior to each slot in the candidate set 604. The node may perform such sensing for each expected periodicity (e.g., each configured periodicity Preserve).

Referring to FIG. 6, in some aspects of the present disclosure, the node may by default only sense in one sensing occasion in the set of slots 606 (i.e., for k=1). In other aspects, the node may alternatively or additionally sense other sensing occasions, for example, in a set of slots 608 (i.e., for k=2) or in further slots (i.e., for k≥3, not shown). Similar as in case of full sensing, in PBPS, the node may determine to exclude one or more resources from the set of candidate slots 604 in view of an overlap with resource reserved by one or more transmissions in the sensing occasions, for example, in the set of slots 606 or in the set of slots 608. Also, similar as in case of full sensing, the remaining resources in the set of candidate resources (e.g., a set of available resources S_{A} in NR) may then be reported (e.g., by the PHY layer) to the MAC layer of the node. In view of processing time at the PHY layer, in some aspects, a time offset 61o (e.g., T_{proc,0}^{SL}) may exist between a last slot in the last sensing occasion (e.g., the occasion of slots 606 for k=1) prior to the set of candidate slots 604 and a time instant of reporting the candidate resources to the MAC layer. Similarly, in view of processing time at the MAC layer, in some aspects, a time offset 612 (e.g., T_{proc,1}^{SL}) may exist between a time instant of reporting the candidate resources to the MAC layer and a first slot in the set of candidate slots 604.

As described above, according to aspects of the present disclosure, a node (e.g., a UE 120a, 120e, a Tx UE or the like) may perform contiguous partial sensing (CPS). FIG. 7 is a diagram illustrating CPS 700 in accordance with various aspects of the present disclosure. The node may, for example, similar as in case of full sensing or PBPS, generate (or obtain) a resource selection trigger in a slot 702 (e.g., SL slot n). Based on a delay budget, a priority, and/or the like, of a sidelink transmission to be transmitted, and/or based on other considerations, the node may determine a set of candidate slots 704 (e.g., Y candidate slots in NR, or the like) in which it generally intends to transmit the sidelink transmission. However, in CPS, unlike as in full sensing and similar as in PBPS, the node does not perform sensing (e.g., monitoring) the channel substantially all the time prior to the slot 702. Rather, in CPS, to determine which resources in the set of candidate slots 704 are reserved by nearby nodes, the node may sense (e.g., monitor) the channel for a contiguous number of slots based on control information (e.g., comprising one or more reservations, periodicities, TRA/FRA, RRI, and/or the like) indicated in sidelink transmission by other nodes, for instance, as described in the context of FIG. 5. Frequency resources sensed in CPS are analogous to frequency resources sensed in full sensing described above and are defined in accordance with a resource pool (e.g., a resource pool in NR).

In one aspect of the present disclosure, in CPS, the node may perform sensing only in sensing occasions associated with reservations for retransmissions. For instance, the node may perform sensing in a contiguous partial sensing window defined by boundaries 706a and 706b. The boundaries 706a and 706b may be determined having regard to control information (e.g., SCI as described in the context of resources 502 and 510 in FIG. 5). For example, the node may consider that control information (e.g., SCI) may indicate up to a number of future reservations for retransmissions (e.g., up to 2 future reservations for retransmissions). In one aspect, the up to 2 future retransmissions may be at most 31 slots apart from the control information. In some aspects of the present disclosure, the boundary 706a of the contiguous partial sensing window may be determined such that it is located a number (e.g., 31) slots 708 before a first slot of the candidate slots 704. The boundary 706a may also be defined relative to the slot 702 and may be referred to as n+T_{A} slot 710 (with n corresponding to slot 702). In some aspects of the present disclosure, the boundary 706b of the contiguous partial sensing window may be determined such that it is shortly before a first slot of the candidate slots 704, but subject to processing constraints occurring in slots 712. The processing constraints in the slots 712 may relate to processing time for sensing result and sidelink transmission preparation time, and may, in some aspects, correspond to time offsets 610 and 612 described in the context of FIG. 6 above. The boundary 706b may also be defined relative to the slot 702 and may be referred to as n+T_{B} slot 714 (with n corresponding to slot 702).

In one or more aspects of the present disclosure, the node may be configured (e.g., pre-configured), for instance, based on a sidelink resource pool, to perform full sensing only, partial sensing (e.g., PBPS and/or CPS) only, random resource selection only, or any combination thereof. The resource pool may be, in some aspects, an SL mode 2 Tx resource pool in NR. PBPS may be for used for detecting periodic reservations (e.g., in control information such as SCI) by nearby nodes. PBPS may be used based on a configuration (e.g., a higher layer parameter, for instance, by RRC signaling, such as sl-MultiReserveResource in NR) of a resource pool. CPS may be used for detecting aperiodic reservations (e.g., in control information such as SCI) of nearby nodes. Partial sensing (PBPS and/or CPS) may be used based on a configuration (e.g., a higher layer parameter, for instance, by RRC signaling, such as sl-multiTBReserve in NR) of a resource pool. In some aspects, if the node intends to perform an aperiodic sidelink transmission with a single TB, the node may perform PBPS and CPS (if reserving multiple resources is enabled in a resource pool, e.g., by a higher layer parameter, for instance, by RRC signaling, such as by sl-MultiReserveResource) or CPS only (if reserving multiple resources is disabled). In addition, in some aspects, if the node determines to perform a periodic sidelink transmission with multiple TBs, the node may perform both, PBPS and CPS (if reserving multiple resources is enabled in a resource pool, e.g., by a higher layer parameter, for instance, by RRC signaling, such as by sl-MultiReserveResource). In the case in which the node performs both, PBPS and CPS, the node may combine sensing results from PBPS and CPS to determine available resources (e.g., a set of available resources S_{A} in NR to be reported to the MAC layer).

In accordance with various aspects described above, a resource selection window (e.g., the resource selection window 406 in FIG. 4) may, in full sensing, start at a time of a resource selection trigger (e.g., the resource selection trigger in the slot 402 in FIG. 4). The resource selection window may end at a time determined by the selection trigger incremented by a packet delay budget (PDB) of a TB for transmission of which the node intends to select resources. In some aspects, in full sensing, the node may have no knowledge with regard to a time (e.g., a slot) in which resource selection may be triggered. Therefore, the node may perform sensing substantially all the time as described above. In an aspect, the node may obtain knowledge about PDB at a time of obtaining the selection trigger (e.g., from a higher layer, for instance, from a MAC layer and/or from an application layer). In accordance with various aspects described above, in partial sensing (e.g., PBPS, CPS), the node may determine a set of candidate slots 604 or 704 at the resource selection trigger 602 or 702, respectively, based on PDB associated with a TB for transmission of which the node intends to select resources. In some aspects, in partial sensing, sensing occasions (for instance, the set of slots 606, the set of slots 608, or the contiguous partial sensing window defined by boundaries 706a and 706b) may be located in a time between the respective resource selection trigger 602 or 702 and the corresponding set of candidate slots 604 or 704. Expressed differently, sensing occasions and candidate slots may not overlap (i.e., may refer to disjoint slots and/or resources).

In accordance with various aspects described above, sensing methods, for instance, full sensing or partial sensing methods (e.g., PBPS, CPS) may be designed for sensing (e.g., monitoring) in a sub-6 GHz channel (e.g., in FR1 in NR). In one or more aspects of the present disclosure, sensing (e.g., monitoring) described in aforementioned methods may advantageously use a receive beam, for instance, when operating in a millimeter wave channel (e.g., in FR2 in NR). However, aspects of the present disclosure are not limited to use of millimeter waves for sensing (e.g., not limited to use of a receive beam in a millimeter wave channel).

Beamforming, which may also be referred to as spatial filtering, directional transmission, or directional reception, is a signal processing technique that may be used at a transmitting node or a receiving node (e.g., a base station 110 or a UE 120a, 120b, 120c, 120e) to shape or steer an antenna beam (e.g., a transmit beam or receive beam) along a spatial path between the transmitting node and the receiving node. An antenna beam (e.g., a transmit beam or receive beam) may also be referred to as a Transmission Configuration Indicator (TCI) state and/or spatial relation. Beamforming may be achieved by combining the signals communicated via antenna elements of an antenna array such that signals propagating at particular orientations with respect to an antenna array experience constructive interference while others experience destructive interference. The adjustment of signals communicated via the antenna elements may include a transmitting node or a receiving node applying certain amplitude and phase offsets to signals carried via each of the antenna elements associated with the node. The adjustments associated with each of the antenna elements may be defined by a beamforming weight set associated with a particular orientation (e.g., with respect to the antenna array of the transmitting node or receiving node, or with respect to some other orientation).

FIG. 8A illustrates an exemplary process flow for creating an aperiodic mode 2 SL transmission grant according to aspects of the present disclosure. At step 810a, a node such as the UE 120a, 120e, e.g., the MAC layer of the node, may decide to create a mode 2 SL transmission grant for transmitting a single MAC PDU. As one skilled in the art will appreciate, the data contained in the PDU may be passed to the MAC layer from higher layers, e.g. from an application that needs to transmit the data via a SL transmission to a receiving node. At step 820a, the node may perform a transmission resource (re)-selection check procedure as explained in detail elsewhere herein. For instance, Tx resource (re-)selection check determines if Tx resource (re-)selection should be performed. Step 820a may be performed to check whether transmission resource (re-)selection should be performed and to determine transmission resource selection parameters such as a resource pool for resource selection, an Li priority (e.g., prio_{Tx}), a remaining PDB, a number of subchannels (e.g., L_{subCH}), and/or the like to the PHY layer. For example, the node may determine that a BFR procedure, an initial beam pair establishment procedure, or a beam refinement procedure is completed and may trigger a sensing-based resource (re-)selection as described elsewhere herein. Further exemplary conditions for such a Tx resource (re-)selection check in the context of 5G NR are for instance listed in section 5.22.1.2 of 3GPP TS 38.321 V16.7.0. For an aperiodic mode 2 SL transmission step 830a yields a positive result and the MAC layer may pass the determined transmission resource selection parameters to the PHY layer and may trigger a sensing-based resource (re-)selection as described elsewhere herein.

At step 840a, the node, e.g., via a suitable PHY layer routine, may select, as described elsewhere herein (cf. FIG. 4, 5, 6, 7, 9 or 10) in a sensing-based manner a set of available SL transmission resources (also denoted S_{A} herein) e.g., via excluding transmission resources that are reserved for other SL transmissions. The set S_{A} is then passed from the PHY layer to the MAC layer, which in step 850a selects, based on the set S_{A}, a set of resources for transmission of the PDU to be transmitted. Based on the selected set of resources for transmission, in step 860a, a new mode 2 SL grant for the node is created and may be used for transmitting data.

FIG. 8B illustrates an exemplary process flow for creating a periodic mode 2 SL transmission grant according to aspects of the present disclosure. At step 810b, the node, e.g., the MAC layer of the node, may decide to create a mode 2 SL transmission grant for transmitting multiple MAC PDUs. As one skilled in the art will appreciate, the data contained in the PDUs may be passed to the MAC layer from higher layers, e.g., from an application that needs to transmit the data via a SL transmission to a receiving UE. At step 820b, the node may perform a transmission resource (re)-selection check procedure as explained in detail elsewhere herein. Step 820b may be performed to check whether transmission resource (re-)selection should be performed and to determine transmission resource selection parameters such as a resource pool for resource selection, an Li priority (e.g., prio_{Tx}), a remaining PDB, a number of subchannels (e.g., L_{subCH}), resource reservation interval (P_{rsvp_Tx}), and/or the like to the PHY layer. For example, the node may determine that a BFR procedure, an initial beam pair establishment procedure, or a beam refinement procedure is completed and may trigger may trigger a sensing-based resource (re-)selection as described elsewhere herein. For a periodic mode 2 SL transmission, step 820b may yield a negative result, e.g., when the node determines that an already existing mode 2 SL grant will likely be sufficient for transmitting the data, and, at step 822b, the UE uses the already existing grant for transmitting the data, that may have been previously determined via a similar grant creation procedure. In this case, a previous selected sidelink grant may be reused for for multiple MAC PDUs for a number of transmissions based on a counter initialized via drawing a random number. Step 820b may also yield a positive result, e.g., when the UE determines that no mode SL grant exists or when the UE determines that the existing grant may likely not be sufficient or not optimal for transmitting the data. In this case, at step 824b, the UE may set a value of a counter that determines for how many SL transmission periods the new SL grant is to be used by the UE for periodic SL transmissions. In some aspects, such a value for the counter may be randomly drawn from a preconfigured range or may be preconfigured by the network. At step 830b, the MAC layer may pass the determined transmission resource selection parameters to the PHY layer and may trigger sensing-based resource (re-)selection as described elsewhere herein.

At step 840b, the UE, e.g., via a suitable PHY layer routine, may select, as described elsewhere herein (cf. FIG. 4, 5, 6, 7, 9 or 10) in a sensing-based manner a set of available SL transmission resources (also denoted S_{A} herein) e.g., via excluding transmission resources that are reserved for other SL transmissions. The set S_{A} is then passed from the PHY layer to the MAC layer which in step 850b selects, based on the set S_{A}, a set of resources for transmission of the PDU to be transmitted. Based on the selected set of resources for transmission, in step 860b, a new mode 2 SL grant for the node is created and may be used for transmitting data.

FIGS. 9A and 9B are block diagrams conceptually illustrating examples of SL transmissions using beamforming, in accordance with various aspects of the present disclosure. A transmitting node 902 (e.g., a UE 120a, 120e, a Tx UE, or the like) may determine to use a millimeter wave channel (e.g., a channel in FR2 in NR, for instance, in a 28 GHz band) or some other channel for a SL transmission 904 destined for a receiving node 906 (e.g., a UE 120a, 120e, a RX UE, or the like). The transmitting node 902 may use beamforming for the SL transmission destined for the receiving node 906 in order to achieve favorable signal-to-noise ratio (SNR) at the receiving node 906. The transmitting node 902 may perform the beamforming by directing a signal carrying the SL transmission to propagate in a desired direction. In some aspects, the desired direction may be a propagation path from the transmitting device 902 to the receiving device 906 that results in a favorable (e.g., maximal) SNR at the receiving device 906. In one or more aspects of the present disclosure, the pair of devices 902 and 906 may have multiple signal propagation paths. In such cases, the node pair 902 and 906 may, depending on beamforming capability, use only a single one signal propagation path. For instance, in some aspects, the transmitting node 902 may use a transmit beam 908 and the receiving device 906 may use a receive beam 910 (shown in FIG. 9A). In other aspects, the transmitting device 902 may use a transmit beam 912 and the receiving device 906 may use a receive beam 914 (shown in FIG. 9B). The use of the transmit beam 912 and the receive beam 914 may involve a reflection of the sidelink transmission 904 on a reflector 916 (e.g., a building, or the like).

In some aspects, a signal strength at a receiving node, e.g., a node performing a SL sensing and resource selection procedure as disclosed elsewhere herein (see FIG. 4 and FIG. 5) may depend on a receive beam configuration used for sensing. Thus, the receive beam configuration used for sensing may, in some aspects, affect whether a particular SCI can be properly received and processed by the receiving node during the sensing window. Further, in some aspects, the receive beam configuration used for sensing may affect the RSRP of received SCI and thus may affect the SL transmission resource selection procedures as disclosed elsewhere herein.

FIG. 9C is a block diagrams conceptually illustrating examples of SL transmissions using beamforming, in accordance with various aspects of the present disclosure. A transmitting node (e.g., Tx UE 902 may be communicating to a receiving node (e.g., Rx UE 906) via a SL connection 904 using beamforming. For example, nodes 902 and 906 may have determined a pair of transmit and receive beams 912 and 914, e.g., via performing an initial beam pair establishment procedure, or a beam refinement procedure. As shown in FIG. 9C the optimal SL beam configuration for a pair of nodes may change in time, e.g., due to mobility of the nodes, or due to a changing signal propagation environment. For example, a reflector 916, e.g., a reflecting surface, may move away from the nodes 902 and 906 and may thus no longer be used for beamformed SL transmissions on the selected propagation path 904. In response, the nodes 902 and 906 may need to recalibrate their respective transmit and receive beam configurations 912 and 914. For example, node 902, or node 906 may determine to initiate a BFR procedure, or a beam refinement procedure. Further, in some cases it may also be necessary to imitate an initial beam pair establishment procedure to resume SL communications between the nodes 902 and 906.

As illustrated in FIG. 9C, alternative propagation paths 905, e.g. via a second reflector 917, that are based on modified, or refined beam configurations for the nodes 902 and 906 may be associated with different sources of interference than the original signal propagation path 904. For example, other nodes 918 involved in SL communications (e.g., Tx UE2 with transmit beam configuration 920) may generate interfering signals. Thus, in some aspects, a previously assigned or selected SL grant of node 902 may no longer be optimal for the recalibrated beam configuration associated with the alternative propagation path 905. Aspects of the present disclosure provide efficient and reliable SL transmissions and improved SL resource selection in such and similar configurations involving beamforming thereby reducing interference and improving overall SL network throughput.

FIG. 10 is a diagram illustrating an example method 1000 performed by a first node, e.g., by a UE 120a, a UE 120e, or the like, in accordance with various aspects of the present disclosure. In some aspects, the process 1000 may include additional blocks, fewer blocks, different blocks, or differently arranged blocks than those depicted in FIG. 10. Additionally, or alternatively, two or more of the blocks of process 1000 may be performed in parallel. For example, process 1000 may be carried out by processing and transmitter circuitry of a node based on executing instructions of a computer program stored in memory.

As shown in FIG. 10, process 1000 may include determining that a BFR procedure, an initial beam pair establishment procedure, or a beam refinement procedure is completed (block 1010). For example such a BFR procedure, initial beam pair establishment procedure, or beam refinement procedure may have been initiated in response to a changing signal propagation environment as illustrated in the example of FIG. 9C.

As further shown in FIG. 10, in some aspects, process 1000 may include performing, based on the determination, a sensing procedure, wherein the sensing procedure comprises receiving SCI from a third node (block 1020). In some aspects, the sensing procedure may be performed based on a receive beam configuration of the first node, wherein the receive beam configuration may be determined based on the completed BFR procedure, the completed initial beam pair establishment procedure, or the completed beam refinement procedure. In some aspects, the SCI may include first information indicative of a transmission priority corresponding to a SL transmission of the third node and second information indicative of reserved SL transmission resources corresponding to the SL transmission of the third node, and performing the sensing procedure may comprise determining a RSRP corresponding to the SC, and comparing the RSRP corresponding to the SCI with a threshold value, wherein the threshold value may be based on the SL transmission priority of the third node. In some aspects, the threshold value may further be based on a transmission priority for the SL transmission of the first node.

In addition, as shown in FIG. 10, in some aspects, process 1000 may include selecting, based on the sensing procedure, a SL grant for a SL transmission to a second node (block 1030). In some aspects, the SL transmission of the first node may comprise a single transport block, and the SL grant may comprise transmission resources for the SL transmission, and transmission resources for one or more HARQ retransmissions. In further aspects, the SL transmission may comprise multiple transport blocks, and the SL grant may comprise transmission resources for the SL transmission, transmission resources for one or more HARQ retransmissions, and a transmission periodicity. In some aspects, selecting the SL grant may comprise clearing one or more previously selected SL grants, e.g., SL grants selected during a previous sensing window. For example, selecting the SL grant may comprise clearing one or more previously selected SL grants associated with a SL process associated with the first node and the second node. Further, selecting the SL grant may also comprise clearing one or more SL grants associated with a HARQ process or a receive node associated with the BFR procedure, the initial beam pair establishment procedure, or the beam refinement procedure.

Moreover, as shown in FIG. 10, in some aspects, process 1000 may include transmitting the SL transmission to the second node based on the selected SL grant (block 1040). In some aspects, performing the sensing procedure may further comprise excluding the reserved SL transmission resources of the third node when selecting the SL grant for the SL transmission if the RSRP value is larger than the threshold value and including the reserved SL transmission resources of the third node when selecting the SL grant for the SL transmission if the RSRP value is less than or equal to the threshold value. In some aspects, the SCI of the third node may be received based on a receive beam configuration of the first node determined via the completed beam BFR procedure, the initial beam pair establishment procedure or the beam refinement procedure for the first node and the second node. In some aspects, selecting the SL grant may comprise determining a set of available transmission resources, wherein determining the set of available transmission resources may comprise excluding, based on the sensing procedure, transmission resources reserved by the third node from a configured set of SL transmission resources, and selecting transmission resources for the SL grant from the set of available transmission resources. Further, selecting the SL grant may comprise selecting transmission resources for the SL grant from a set of available transmission resources, wherein the set of available transmission resources excludes transmission resources corresponding to the third node based on the sensing procedure. In some aspects, the SL transmission of the first node may comprise multiple transport blocks and process 1000 may further comprise determining that a SL grant reselection counter expires, and performing, based on the determination, the beam refinement procedure.

Aspects disclosed herein thus improve SL resource (re)selection when using beamforming for SL transmissions. For example, aspects of the present disclosure allow a node to perform a threshold and priority based decision whether or not to exclude transmission resources based on SCI received form other nodes during sensing with a recalibrated receive beam configuration. In this manner, the available system bandwidth can be better used and interference among nodes is reduced.

In one or more aspects of the present disclosure, as an alternative or in addition to the aspects described above, the node (e.g. a UE) may be configured to operate at least in part in accordance with one or more Technical Specifications (TS) produced by a third Generation Partnership Project (3GPP).

In the following, several aspects of the present disclosure are presented:
Aspect 1. A method for wireless communication by a first node, comprising: determining that a beam failure recovery (BFR) procedure, an initial beam pair establishment procedure, or a beam refinement procedure is completed; performing, based on the determination, a sensing procedure, wherein the sensing procedure comprises receiving sidelink (SL) control information (SCI) from a third node; selecting, based on the sensing procedure, a SL grant for a SL transmission to a second node; and transmitting the SL transmission to the second node based on the selected SL grant.
Aspect 2. The method of aspect 1, wherein the sensing procedure is performed based on a receive beam configuration of the first node, wherein the receive beam configuration is determined based on the completed BFR procedure, the completed initial beam pair establishment procedure, or the completed beam refinement procedure.
Aspect 3. The method of any one of aspects 1 to 2, wherein the SL transmission comprises a single transport block, and wherein the SL grant comprises: transmission resources for the SL transmission, and transmission resources for one or more HARQ retransmissions.
Aspect 4. The method of any one of aspects 1 to 2, wherein the SL transmission comprises multiple transport blocks, and wherein the SL grant comprises: transmission resources for the SL transmission, transmission resources for one or more HARQ retransmissions, and a transmission periodicity.
Aspect 5. The method of any one of aspects 1 to 4, wherein selecting the SL grant comprises: clearing one or more previously selected SL grants.
Aspect 6. The method of aspect 5, wherein selecting the SL grant comprises: clearing one or more previously selected SL grants associated with a SL process associated with the first node and the second node.
Aspect 7. The method of aspect 5, wherein selecting the SL grant comprises: clearing one or more SL grants associated with a HARQ process or a receive node associated with the BFR procedure, the initial beam pair establishment procedure, or the beam refinement procedure.
Aspect 8. The method of any one of aspects 1 to 7, wherein the SCI includes first information indicative of a transmission priority corresponding to a SL transmission of the third node and second information indicative of reserved SL transmission resources corresponding to the SL transmission of the third node, and wherein performing the sensing procedure further comprises: determining a reference signal received power RSRP corresponding to the SCI; and comparing a the reference signal received power (RSRP) corresponding to the SCI with a threshold value, wherein the threshold value is based on the SL transmission priority of the third node.
Aspect 9. The method of aspect 8, wherein the threshold value is further based on a transmission priority for the SL transmission of the first node.
Aspect 10. The method of aspect 8, wherein performing the sensing procedure further comprises: excluding the reserved SL transmission resources of the third node when selecting the SL grant for the SL transmission if the RSRP value is larger than the threshold value; and including the reserved SL transmission resources of the third node when selecting the SL grant for the SL transmission if the RSRP value is less or equal than the threshold value.
Aspect 11. The method of any one of aspects 2 to 10, wherein the SCI of the third node is received based on a receive beam configuration of the first node determined via the completed beam BFR procedure, the initial beam pair establishment procedure or the beam refinement procedure for the first node and the second node.
Aspect 12. The method of any one of aspects 1 to 11, wherein selecting the SL grant comprises: determining a set of available transmission resources, wherein determining the set of available transmission resources comprises excluding, based on the sensing procedure, transmission resources reserved by the third node from a configured set of SL transmission resources; and selecting transmission resources for the SL grant from the set of available transmission resources.
Aspect 13. The method of any one of aspects 1 to 12, wherein selecting the SL grant comprises selecting transmission resources for the SL grant from a set of available transmission resources, wherein the set of available transmission resources excludes transmission resources corresponding to the third node based on the sensing procedure.
Aspect 14. The method of any one of aspects 1 to 13, wherein the SL transmission comprises multiple transport blocks and the method further comprising: determining that a SL grant reselection counter expires; and performing, based on the determination, the beam refinement procedure.
Aspect 15. An apparatus for wireless communication, the apparatus comprising: means for determining that a beam failure recovery (BFR) procedure, an initial beam pair establishment procedure, or a beam refinement procedure is completed; means for performing, based on the determination, a sensing procedure, wherein the sensing procedure comprises receiving SL control information (SCI) from a third node; means for selecting, based on the sensing procedure, a sidelink (SL) grant for a SL transmission to a second node; and means for transmitting the SL transmission to the second node based on the selected SL grant. The apparatus for wireless communication may further comprise means for carrying out the steps of aspects 2 to 14.
Aspect 16. An apparatus for wireless communication of a first node, the apparatus comprising: a memory; and one or more processors coupled to the memory, the memory and the one or more processors being configured to: determine that a beam failure recovery (BFR) procedure, an initial beam pair establishment procedure, or a beam refinement procedure is completed; perform, based on the determination, a sensing procedure, wherein the sensing procedure comprises receiving SL control information (SCI) from a third node; select, based on the sensing procedure, a sidelink (SL) grant for a SL transmission to a second node; and transmit the SL transmission to the second node based on the selected SL grant.
Aspect 17. The apparatus of aspect 16, wherein the memory and the one or more processors, are further configured to perform the sensing procedure based on a receive beam configuration of the first node and determine the receive beam configuration based on the completed BFR procedure, the completed initial beam pair establishment procedure, or the completed beam refinement procedure.
Aspect 18. The apparatus of any one of aspects 16 to 17, wherein the SL transmission comprises a single transport block, and wherein the SL grant comprises: transmission resources for the SL transmission, and transmission resources for one or more HARQ retransmissions.
Aspect 19. The apparatus of any one of aspects 16 to 17, wherein the SL transmission comprises multiple transport blocks, and wherein the SL grant comprises: transmission resources for the SL transmission, transmission resources for one or more HARQ retransmissions, and a transmission periodicity.
Aspect 20. The apparatus of any one of aspects 16 to 19, wherein the memory and the one or more processors, when selecting the SL grant, are further configured to: clear one or more previously selected SL grants corresponding to the first node for which the beam failure was detected, for which BFR was performed, for which initial beam pair was established, or for which beam refinement was performed.
Aspect 21. The apparatus of aspect 20, wherein the memory and the one or more processors, when selecting the SL grant, are further configured to: clear one or more previously selected SL grants associated with a SL process associated with the first node and the second node.
Aspect 22. The apparatus of aspect 20, wherein the memory and the one or more processors, when selecting the SL grant, are further configured to: clear one or more SL grants associated with a HARQ process or a receive node associated with the BFR procedure, the initial beam pair establishment procedure, or the beam refinement procedure.
Aspect 23. The apparatus of any one of aspects 16 to 22, wherein the SCI includes first information indicative of a transmission priority corresponding to a SL transmission of the third node and second information indicative of reserved SL transmission resources corresponding to the SL transmission of the third node, and wherein the memory and the one or more processors, when performing the sensing procedure further are further configured to: determine a reference signal received power, RSRP, corresponding to the SCI; and compare the RSRP corresponding to the SCI with a threshold value, wherein the threshold value is based on the SL transmission priority of the third node.
Aspect 24. The apparatus of any one of aspects 16 to 23, wherein the wherein the memory and the one or more processors are configured to receive the SCI of the third node based on a receive beam configuration of the first node determined via the completed beam BFR procedure, the initial beam pair establishment procedure or the beam refinement procedure for the first node and the second node.
Aspect 25. A non-transitory computer-readable medium storing one or more instructions for wireless communication, the one or more instructions, when executed by one or more processors, cause the one or more processors to: determine that a BFR procedure, an initial beam pair establishment procedure, or a beam refinement procedure is completed; perform, based on the determination, a sensing procedure, wherein the sensing procedure comprises receiving SCI from a third node; select, based on the sensing procedure, a SL grant for a SL transmission to a second node; and transmit the SL transmission to the second node based on the selected SL grant.
Aspect 26. The non-transitory computer-readable medium of aspect 25, wherein the one or more instructions further cause the one or more processors to perform the sensing procedure based on a receive beam configuration of the first node; and determine the receive beam configuration based on the completed BFR procedure, the completed initial beam pair establishment procedure, or the completed beam refinement procedure.
Aspect 27. The non-transitory computer-readable medium of any one of aspects 25 to 26, wherein the one or more instructions, when causing to select the SL grant are further configured to cause the one or more processors to: clear one or more previously selected SL grants corresponding to the first node for which the beam failure was detected, for which BFR was performed, for which initial beam pair was established, or for which beam refinement was performed.
Aspect 28. The non-transitory computer-readable medium of any one of aspects 25 to 27, wherein the SCI includes first information indicative of a transmission priority corresponding to a SL transmission of the third node and second information indicative of reserved SL transmission resources corresponding to the SL transmission of the third node, and wherein the one or more instructions, when causing to perform the sensing procedure are further configured to cause the one or more processors to: determine a reference signal received power, RSRP, corresponding to the SCI; and compare the RSRP corresponding to the SCI with a threshold value, wherein the threshold value is based on the SL transmission priority of the third node.
Aspect 29. The non-transitory computer-readable medium of any one of aspects 25 to 28, wherein the one or more instructions are further configured to cause the one or more processors to: receive the SCI of the third node based on a receive beam configuration of the first node determined via the completed beam BFR procedure, the initial beam pair establishment procedure or the beam refinement procedure for the first node and the second node.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software.

It will be apparent that systems and/or methods described herein may be implemented in different forms of hardware, firmware, or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of various aspects. In fact, many of these features may be combined in ways not specifically recited in the claims and/or dis-closed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, a-b-c, or any combination with multiples of the same element (e.g., a-a, a-a-a, a-a-b, a-a-c, a-b-b, a-c-c, b-b, b-b-b, b-b-c, c-c, c-c-c, or any other ordering of a, b, and c).

No element, act, or instruction used herein should be construed as critical or essential unless explicitly described as such. Also, as used herein, the articles “a” and “an” are intended to include one or more items, and may be used interchangeably with “one or more.” Furthermore, as used herein, the terms “set” and “group” are intended to include one or more items (e.g., related items, unrelated items, a combination of related and unrelated items, and/or the like), and may be used interchange-ably with “one or more.” Where only one item is intended, the phrase “only one” or similar language is used. Also, as used herein, the terms “has,” “have,” “having,” and/or the like are intended to be open-ended terms.

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

As used herein, the term “or” is an inclusive “or” unless limiting language is used relative to the alternatives listed. For example, reference to “X being based on A or B” shall be construed as including within its scope X being based on A, X being based on B, and X being based on A and B. In this regard, reference to “X being based on A or B” refers to “at least one of A or B” or “one or more of A or B” due to “or” being inclusive. Similarly, reference to “X being based on A, B, or C” shall be construed as including within its scope X being based on A, X being based on B, X being based on C, X being based on A and B, X being based on A and C, X being based on B and C, and X being based on A, B, and C. In this regard, reference to “X being based on A, B, or C” refers to “at least one of A, B, or C” or “one or more of A, B, or C” due to “or” being inclusive. As an example of limiting language, reference to “X being based on only one of A or B” shall be construed as including within its scope X being based on A as well as X being based on B, but not X being based on A and B.

What is claimed is:

1. A method for wireless communication by a first node, comprising:
determining that a beam failure recovery (BFR) procedure, an initial beam pair establishment procedure, or a beam refinement procedure is completed;
performing, based on the determination, a sensing procedure, wherein the sensing procedure comprises receiving sidelink (SL) control information (SCI) from a third node;
selecting, based on the sensing procedure, a SL grant for a SL transmission to a second node; and
transmitting the SL transmission to the second node based on the selected SL grant.

2. The method of claim 1, wherein the sensing procedure is performed based on a receive beam configuration of the first node, wherein the receive beam configuration is determined based on the completed BFR procedure, the completed initial beam pair establishment procedure, or the completed beam refinement procedure.

3. The method of claim 1, wherein the SL transmission comprises a single transport block, and wherein the SL grant comprises:
transmission resources for the SL transmission, and
transmission resources for one or more HARQ retransmissions.

4. The method of claim 1, wherein the SL transmission comprises multiple transport blocks, and wherein the SL grant comprises:
transmission resources for the SL transmission,
transmission resources for one or more HARQ retransmissions, and
a transmission periodicity.

5. The method of claim 1, wherein selecting the SL grant comprises:
clearing one or more previously selected SL grants.

6. The method of claim 5, wherein selecting the SL grant comprises:
clearing one or more previously selected SL grants associated with a SL process associated with the first node and the second node.

7. The method of claim 5, wherein selecting the SL grant comprises:
clearing one or more SL grants associated with a HARQ process or a receive node associated with the BFR procedure, the initial beam pair establishment procedure, or the beam refinement procedure.

8. The method of claim 1, wherein the SCI includes first information indicative of a transmission priority corresponding to a SL transmission of the third node and second information indicative of reserved SL transmission resources corresponding to the SL transmission of the third node, and wherein performing the sensing procedure further comprises:
determining a reference signal received power RSRP corresponding to the SCI; and
comparing the RSRP corresponding to the SCI with a threshold value, wherein the threshold value is based on the SL transmission priority of the third node.

9. The method of claim 8, wherein the threshold value is further based on a transmission priority for the SL transmission of the first node.

10. The method of claim 8, wherein performing the sensing procedure further comprises:
excluding the reserved SL transmission resources of the third node when selecting the SL grant for the SL transmission if the RSRP value is larger than the threshold value; and
including the reserved SL transmission resources of the third node when selecting the SL grant for the SL transmission if the RSRP value is less or equal than the threshold value.

11. The method of claim 2, wherein the SCI of the third node is received based on a receive beam configuration of the first node determined via the completed beam BFR procedure, the initial beam pair establishment procedure or the beam refinement procedure for the first node and the second node.

12. The method of claim 1, wherein selecting the SL grant comprises:
determining a set of available transmission resources, wherein determining the set of available transmission resources comprises excluding, based on the sensing procedure, transmission resources reserved by the third node from a configured set of SL transmission resources; and
selecting transmission resources for the SL grant from the set of available transmission resources.

13. The method of claim 1, wherein selecting the SL grant comprises selecting transmission resources for the SL grant from a set of available transmission resources, wherein the set of available transmission resources excludes transmission resources corresponding to the third node based on the sensing procedure.

14. The method of claim 1, wherein the SL transmission comprises multiple transport blocks and the method further comprising:
determining that a SL grant reselection counter expires; and
performing, based on the determination, the beam refinement procedure.

15. An apparatus for wireless communication of a first node, the apparatus comprising:
means for determining that a beam failure recovery (BFR) procedure, an initial beam pair establishment procedure, or a beam refinement procedure is completed;
means for performing, based on the determination, a sensing procedure, wherein the sensing procedure comprises receiving SL control information (SCI) from a third node;
means for selecting, based on the sensing procedure, a sidelink (SL) grant for a SL transmission to a second node; and
means for transmitting the SL transmission to the second node based on the selected SL grant.

16. An apparatus for wireless communication of a first node, the apparatus comprising:
a memory; and
one or more processors coupled to the memory, the memory and the one or more processors being configured to:
determine that a beam failure recovery (BFR) procedure, an initial beam pair establishment procedure, or a beam refinement procedure is completed;
perform, based on the determination, a sensing procedure, wherein the sensing procedure comprises receiving SL control information (SCI) from a third node;
select, based on the sensing procedure, a sidelink (SL) grant for a SL transmission to a second node; and
transmit the SL transmission to the second node based on the selected SL grant.

17. The apparatus of claim 16, wherein the memory and the one or more processors, are further configured to
perform the sensing procedure based on a receive beam configuration of the first node and
determine the receive beam configuration based on the completed BFR procedure, the completed initial beam pair establishment procedure, or the completed beam refinement procedure.

18. The apparatus of claim 16, wherein the SL transmission comprises a single transport block, and wherein the SL grant comprises:
transmission resources for the SL transmission, and
transmission resources for one or more HARQ retransmissions.

19. The apparatus of claim 16, wherein the SL transmission comprises multiple transport blocks, and wherein the SL grant comprises:
transmission resources for the SL transmission,
transmission resources for one or more HARQ retransmissions, and
a transmission periodicity.

20. The apparatus of claim 16, wherein the memory and the one or more processors, when selecting the SL grant, are further configured to:
clear one or more previously selected SL grants corresponding to the first node for which the beam failure was detected, for which BFR was performed, for which initial beam pair was established, or for which beam refinement was performed.

21. The apparatus of claim 21, wherein the memory and the one or more processors, when selecting the SL grant, are further configured to:
clear one or more previously selected SL grants associated with a SL process associated with the first node and the second node.

22. The apparatus of claim 21, wherein the memory and the one or more processors, when selecting the SL grant, are further configured to:
clear one or more SL grants associated with a HARQ process or a receive node associated with the BFR procedure, the initial beam pair establishment procedure, or the beam refinement procedure.

23. The apparatus of claim 16, wherein the SCI includes first information indicative of a transmission priority corresponding to a SL transmission of the third node and second information indicative of reserved SL transmission resources corresponding to the SL transmission of the third node, and wherein the memory and the one or more processors, when performing the sensing procedure further are further configured to:
determine a reference signal received power, RSRP, corresponding to the SCI; and
compare the RSRP corresponding to the SCI with a threshold value, wherein the threshold value is based on the SL transmission priority of the third node.

24. The apparatus of claim 16, wherein the wherein the memory and the one or more processors are configured to
receive the SCI of the third node based on a receive beam configuration of the first node determined via the completed beam BFR procedure, the initial beam pair establishment procedure or the beam refinement procedure for the first node and the second node.

25. A non-transitory computer-readable medium storing one or more instructions for wireless communication, the one or more instructions, when executed by one or more processors of a wireless communication apparatus of a first node, cause the one or more processors to:
determine that a beam failure recovery (BFR) procedure, an initial beam pair establishment procedure, or a beam refinement procedure is completed;
perform, based on the determination, a sensing procedure, wherein the sensing procedure comprises receiving SL control information (SCI) from a third node;
select, based on the sensing procedure, a sidelink (SL) grant for a SL transmission to a second node; and
transmit the SL transmission to the second node based on the selected SL grant.

26. The non-transitory computer-readable medium of claim 25, wherein the one or more instructions further cause the one or more processors to perform the sensing procedure based on a receive beam configuration of the first node; and
determine the receive beam configuration based on the completed BFR procedure, the completed initial beam pair establishment procedure, or the completed beam refinement procedure.

27. The non-transitory computer-readable medium of claim 25, wherein the one or more instructions, when causing to select the SL grant are further configured to cause the one or more processors to:
clear one or more previously selected SL grants corresponding to the first node for which the beam failure was detected, for which BFR was performed, for which initial beam pair was established, or for which beam refinement was performed.

28. The non-transitory computer-readable medium of claim 25, wherein the SCI includes first information indicative of a transmission priority corresponding to a SL transmission of the third node and second information indicative of reserved SL transmission resources corresponding to the SL transmission of the third node, and wherein the one or more instructions, when causing to perform the sensing procedure are further configured to cause the one or more processors to:
determine a reference signal received power, RSRP, corresponding to the SCI; and
compare the RSRP corresponding to the SCI with a threshold value, wherein the threshold value is based on the SL transmission priority of the third node.

29. The non-transitory computer-readable medium of claim 25, wherein the one or more instructions are further configured to cause the one or more processors to:
receive the SCI of the third node based on a receive beam configuration of the first node determined via the completed beam BFR procedure, the initial beam pair establishment procedure or the beam refinement procedure for the first node and the second node.
